(19) United States
(12) Patent Application Publication
(10) Pub. No.: US 2016/0168344 A1
(43) Pub. Date: Jun. 16, 2016

(54) WOOD-PLASTIC COMPOSITE MATERIAL

(71) Applicant: TEAL CEDAR PRODUCTS LTD., Surrey (CA)

(72) Inventor: Richard Gerhard JONES, Surrey (CA)

(73) Assignee: TEAL CEDAR PRODUCTS LTD., Surrey (CA)

(21) Appl. No.: 14/965,157

(22) Filed: Dec. 10, 2015

Related U.S. Application Data
(60) Provisional application No. 62/089,974, filed on Dec. 10, 2014.

(51) Int. Cl. C08J 5/04

(52) U.S. Cl. CPC C08J 5/045; C08J 2323/06; C08J 2397/02; C08J 2423/06; C08J 2497/02; C08J 2451/00

(57) ABSTRACT

The present document describes a composite material comprising plastic, rock dust and sawdust in predetermined proportions. In embodiments the material comprises recycled plastic, limestone and hemlock or cedar sawdust. There are also disclosed methods for making the composition and shingles made using the composition.

### CROSS-REFERENCE TO RELATED APPLICATIONS

This application claims priority of U.S. provisional patent application 62/089,974, filed Dec. 10, 2014, the specification of which is hereby incorporated by reference.

### BACKGROUND

(a) Field

The subject matter disclosed generally relates to composite materials, and more particularly to composite materials that comprise high and low density plastics, rock dust and sawdust.

(b) Related Prior Art

Natural wood material used in building can be damaged by water, sunlight, or other elements. Therefore, much research has been performed to develop wood-plastic composite material in order to eliminate the problems associated with natural wood. In previous wood-plastic composite material, granular or pelletized wood fiber and synthetic resin are mixed in a predetermined mixing ratio. Other wood-plastic composite materials include stone materials with synthetic resin, which are mixed in a predetermined mixing ratio. Wood-plastic composite material integrates the wood and advantages of plastic as a whole, has the advantages of light weight, high strength, low cost and environmental protection, the obvious advantage of efficiency, and cost on the dual advantages of high performance. Wood-plastic composite materials are increasingly replacing the other traditional material. Although wood-plastic composite materials have advantages in the practical application, however, because of the polarity of the wood fibers and non-polar plastic, compatibility is poor, and the material causes defects that decrease its performance. The current technology used to produce a wood-plastic pellets or profiles, is inadequate to meet compound moisture and fiber encapsulation requirements. If possible, 0% internal moisture is desired and 0.5% external moisture is desired, with a 92% desired minimum fiber encapsulation in the compounded pellet or profiles. Current wood-plastic composite pelletizing equipment is limited to 1.5% internal and/or external moisture, and a 75% to 80% fiber encapsulation in the pellet. These moisture limitations are created by the use of cooling water with the pelletizer, used to convey the pellets from the die head. It is also limited by efficiency of the vacuum venting systems on the extruder barrel.

Poor fiber encapsulation increases the ambient moisture re-hydration. Any increases in moisture stabilization within profiled shingles creates warpage and structure deformation. The rehydration should be gradual and extend over a 30 day period. Higher moisture content can also degrade the polymer, changing viscosity & creating some brittleness within the structure.

Therefore, there is a need for further improvements to improve the performance of wood-plastic materials, such as heat insulating performance, sound insulation performance, lightness and costs of fabrication, and the like.

There is also a need to further improve the performance of wood-plastic materials by reducing the internal moisture and/or external moisture.

There is also a need to further improve the performance of wood-plastic materials by increases in moisture stabilization within to obtain gradual rehydration over an extended period.

### SUMMARY

According to an embodiment, there is provided a composite material comprising:
a) between about 2% to about 5% w/w low density plastic;
b) between about 30% to about 38% w/w high density plastic;
c) between about 0% to about 40% w/w rock dust;
d) between about 20% to about 50% w/w sawdust; and
e) a coupling agent.

The sawdust may be hemlock sawdust, cedar sawdust or combinations thereof.

The sawdust has a particle size of between about 250 and about 425 microns (60 to 40 mesh).

The rock dust has a particle size of between about 3 and about 10 microns, or about 4 to about 5 microns.

The rock dust may be a calcium carbonate (CaCO₃) mineral.

The calcium carbonate (CaCO₃) mineral may be calcite, aragonite, or a combination thereof.

The calcium carbonate (CaCO₃) mineral may be limestone.

The low density plastic may be low density polyethylene, low density polypropylene, or a combination thereof.

The low density plastic or the high density plastic may be a polyvinylchloride (PVC), a polyethylene, a terephthalate (PET), a polytetrafluoroethylene (PTFE), a polystyrene, a polyvinylidine chloride.

The high density plastic may be high density polyethylene, high density polypropylene, or a combination thereof.

The low density plastic or the high density plastic may be recycled plastic.

The coupling agent may be a maleic anhydride-grafted resin.

The coupling agent may be at about 1 to about 4% w/w of the composition.

The composite material may further comprise a light stabilizer.

The light stabilizer may be a UV absorber, a UV quencher, a hindered amine light stabilizer (HALS), or combinations thereof.

The composite material may comprise from about 2% to about 5% w/w of the light stabilizer.

The composite material may further comprise a flame retardant.

The flame retardant may be mineral wool, gypsum, perlite, calcium silicate (Ca₂SiO₄), aluminium hydroxide (AlOH), magnesium hydroxide (Mg(OH)₂), zinc borate, huntite, hydromagnesite, red phosphorus, chlorendic acid derivatives, chlorinated paraffins, decabromodiphenyl ether, decabromodiphenyl ethane, polymeric brominated compounds such as brominated polystyrenes, brominated epoxy oligomers, tetrabromophthalic anyhydride, tetrabromobisphenol A, hexabromocyclododecane, antimony trioxide, triphenyl phosphate, resorcinol bis(diphenylphosphate), bisphenol A diphenyl phosphate, and tricresyl phosphate (TCP), dimethyl methylphosphonate, aluminum diethyl phosphinate, tris(2,3-dibromopropyl)phosphate, tris(1,3-dichloro-2-propyl)phosphate, and tetrekis(2-chlorethyl)dichloroisopentyldiphosphate, and combinations thereof.

The composite material may further comprise a colorant.

The composite material may further comprise an antimicrobial agent.

The composite material of the present invention may comprise:
a) about 3 to about 4% w/w low density plastic;
b) about 30 to about 36% high density plastic;
c) about 0 to about 37% w/w rock dust;
d) about 20% to about 48% w/w sawdust;
e) about 2 to about 3% w/w of light stabilizer; and
f) about 2% colorant.

According to another embodiment, there is provided a method of preparing a composite material according to the present invention, comprising:
a) intermixing a melted low density plastic and a melted high density plastic with the sawdust and rock dust, to obtain a mixture.

The melted low density plastic or the melted high density plastic may be obtained from melting at about 160° C. to about 200° C.

The melting may occur in a closed vessel.

The method of the present invention may further comprise step b):
b) cooling the mixture on a conveyor.

The method the present invention may further comprise step c):
c) extruding the mixture to obtain a product therefrom.

The extruding may comprise forming and shaping the composite material according to a shape of the product.

The product may be a shingle or a siding panel.

According to another embodiment, there is provided a method of preparing a composite material according to the present invention, comprising:
a) intermixing a melted low density plastic and a melted high density plastic with said sawdust, rock dust and coupling agent, in a ultrahigh-speed thermo-kinetic mixer/compounder to obtain a mixture.

The method may further comprise step b):
b) discharge said mixture into a hot melt cutter enclosed within a temperature/humidity controlled chamber to form a cut material.

The method may further comprise step c):
c) forming and shaping said cut material according to a shape of a product.

The low density plastic or said high density plastic is obtained from melting at about 160° C. to about 200° C.

The product may be a shingle or a siding panel.

The following terms are defined below.

In this disclosure, the word “comprising” is used in a non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements. In this disclosure the recitation of numerical ranges by endpoints includes all numbers subsumed within that range including all whole numbers, all integers and all fractional intermediates (e.g., 1 to 5 includes 1, 1.5, 2, 2.75, 3, 3.80, 4, and 5 etc.).

In this disclosure the singular forms a “an”, and “the” include plural referents unless the content clearly dictates otherwise. Thus, for example, reference to a composition containing “a compound” includes a mixture of two or more compounds.

In this disclosure term “or” is generally employed in its sense including “and/or” unless the content clearly dictates otherwise. In this disclosure, unless otherwise indicated, all numbers expressing quantities or ingredients, measurement of properties and so forth used in the specification and claims are to be understood as being modified in all instances by the term “about”. Accordingly, unless indicated to the contrary or necessary in light of the context, the numerical parameters set forth in the disclosure are approximations that can vary depending upon the desired properties sought to be obtained by those skilled in the art utilizing the teachings of the present disclosure and in light of the inaccuracies of measurement and quantification. Without limiting the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, their numerical values set forth in the specific examples are understood broadly only to the extent that this is consistent with the validity of the disclosure and the distinction of the subject matter disclosed and claimed from the prior art.

In this disclosure the term “additive” means any additions to a mixture which are present in relatively low quantities, but whose presence is desired by a user for other reasons. In embodiment zinc borate is used as an additive, in other embodiments a coloring agent is used as an additive. By way of example and not limitation, an additive may be used to prevent or reduce bacterial, algal or moss growth or to prevent degradation, or to color or change the appearance of the material, or to help the material cure. In embodiments an additive may be a coupling agent.

In this disclosure the term “Mesh” means U.S. filter mesh sizes and the mesh size represents the number of openings per square inch. It will be understood that in particular embodiments the particle sizes for individual components may be larger or smaller than those presented for the illustrative embodiments.

In this disclosure the term “sawdust” means and includes any form of fragmented wood material.

In this disclosure the term “rock” or “mineral”, “rock dust” means and includes all suitable forms of inanimate matter. It will be understood by those skilled in the art that in embodiments the rock may be relatively soft or otherwise easy to fragment, grind or reduce to powder. In embodiments the rock may be relatively porous. In particular embodiments the rock is or comprises limestone or similar materials. In embodiments the limestone powder may be waste from other processes.

In this disclosure the term “melting” refers to heating a plastic component or mixture of components comprising plastic, so that the plastic adopts a substantially liquid consistency so that the plastic and other components can be substantially homogeneously intermixed. In embodiments melting may occur at any suitable temperature and in embodiments occurs at between about 160° C. and about 200° C. Where the plastic used is or comprises polypropylene, a suitable temperature is about 180° C. and where the plastic used is or comprises polyethylene then a suitable temperature is about 170° C., but in embodiments temperatures of about 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., 200° C., or greater than about 200° C. will be suitable. Those skilled in the art will readily select a suitable melting temperature to take account of the properties of the particular plastic used and of the mixture of components.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a method according to an embodiment of the present invention.

### DETAILED DESCRIPTION

In embodiments there is disclosed a composite material comprising:
a) between about 2% to about 5% w/w low density plastic;
b) between about 30% to about 38% w/w high density plastic;
c) between about 0% to about 40% w/w rock dust;
d) between about 20% to about 50% w/w sawdust; and
e) a coupling agent.

In embodiments, the term “plastic” means any suitable plastic. In particular embodiments plastic includes low density and high density plastics, and include, as preferred embodiments polyethylene or polypropylene of high and low densities. In embodiments plastic may be recycled. In embodiments plastic is provided in the form of pellets or shredded or otherwise comminuted plastic. In embodiments the plastic comprises any suitable mixture of polypropylene and polyethylene. According to some embodiments the plastic comprises other components. In embodiments the plastic may be polyvinylchloride (PVC), polyethylene terephthalate (PET), polytetrafluoroethylene (PTFE), polystyrene, poyvinylidine chloride (Saran), low density polyethylene and high density polyethylene (HDPE and LDPE), or combinations thereof.

In particular embodiment, the high density plastic may be a 4-6 melt range injection or extrusion grade extrusion natural resin in pellet or re-grind form. Resin will require a processing range between 180-195° C.

In particular embodiment, the low density plastic may be a 5-7 melt range injection or extrusion grade natural virgin resin.

The composite material of the present invention may comprise between about 2% to about 5% w/w, or from about 2% to about 4% w/w, or from about 2% to about 3% w/w, or from about 3% to about 5% w/w, or from about 3% to about 4%, or from about 4% to about 5% w/w, and preferably 3% or 4% w/w low density plastic.

The composite material of the present invention may comprise between about 30% to about 38% w/w, or from about 30% to about 37% w/w, or from about 30% to about 36% w/w, or from about 30% to about 35% w/w, or from about 30% to about 34% w/w, or from about 30% to about 33% w/w, or from about 30% to about 32% w/w, or from about 30% to about 31% w/w, or about 31% to about 38% w/w, or from about 31% to about 37% w/w, or from about 31% to about 36% w/w, or from about 31% to about 35% w/w, or from about 31% to about 34% w/w, or from about 31% to about 33% w/w, or from about 31% to about 32% w/w, or about 32% to about 38% w/w, or from about 32% to about 37% w/w, or from about 32% to about 36% w/w, or from about 32% to about 35% w/w, or from about 32% to about 34% w/w, or from about 32% to about 33% w/w, or about 33% to about 38% w/w, or from about 33% to about 37% w/w, or from about 33% to about 36% w/w, or from about 33% to about 35% w/w, or from about 33% to about 34% w/w, or about 34% to about 38% w/w, or from about 34% to about 37% w/w, or from about 34% to about 36% w/w, or from about 34% to about 35% w/w, or about 35% to about 38% w/w, or from about 35% to about 37% w/w, or from about 35% to about 36% w/w, or about 36% to about 38% w/w, or from about 36% to about 37% w/w, or about 37% to about 38% w/w, or about 30, 31, 32, 33, 34, 35, 36, 37, 38% w/w high density plastic.

In embodiments, the term “rock dust” is dust from any suitable forms of inanimate matter. It will be understood by those skilled in the art that in embodiments the rock may be relatively soft or otherwise easy to fragment, grind or reduce to powder. In embodiments the rock may be relatively porous. In particular embodiments the rock dust is or comprises limestone or similar materials. In particular embodiments the rock dust is or comprises a calcium carbonate (CaCO₃) mineral. In particular embodiments, the calcium carbonate (CaCO₃) mineral is calcite, aragonite, or a combination thereof. In particular embodiments, the calcium carbonate (CaCO₃) mineral is limestone. In embodiments the limestone powder may be waste from other processes.

In particular embodiment, the rock dust or rock powder has a water content of about 1% to about 5%, or about 1% to about 4%, or about 1% to about 3%, or about 1% to about 3%, or about 2% to about 5%, or about 2% to about 4%, or about 2% to about 3%, or about 3% to about 5%, or about 3% to about 4%, or about 4% to about 5%. In embodiments the rock is limestone.

According to an embodiment, the composite material of the present invention comprises between about 0% to about 40% w/w, or from about 0% to about 35% w/w, or from about 0% to about 30% w/w, or from about 0% to about 25% w/w, or from about 0% to about 20% w/w, or from about 0% to about 15% w/w, or from about 0% to about 10% w/w, or from about 0% to about 5% w/w, or about 5% to about 40% w/w, or from about 5% to about 35% w/w, or from about 5% to about 30% w/w, or from about 5% to about 25% w/w, or from about 5% to about 20% w/w, or from about 5% to about 15% w/w, or from about 5% to about 10% w/w, or about 10% to about 40% w/w, or from about 10% to about 35% w/w, or from about 10% to about 30% w/w, or from about 10% to about 25% w/w, or from about 10% to about 20% w/w, or from about 10% to about 15% w/w, or about 15% to about 40% w/w, or from about 15% to about 35% w/w, or from about 15% to about 30% w/w, or from about 15% to about 25% w/w, or from about 15% to about 20% w/w, or about 20% to about 40% w/w, or from about 20% to about 35% w/w, or from about 20% to about 30% w/w, or from about 20% to about 25% w/w, or about 25% to about 40% w/w, or from about 25% to about 35% w/w, or from about 25% to about 30% w/w, or about 30% to about 40% w/w, or from about 30% to about 35% w/w or about 35% to about 40% w/w, or about 0, 1, 2, 3, 4, 5, 6, 7, 8, 9, 10, 11, 12, 13, 14, 15, 165, 17, 18, 19, 20, 21, 22, 23, 24, 25, 26, 27, 28, 29, 30, 31, 32, 33, 34, 35, 36, 37, 38, 39, 40% w/w rock dust.

In embodiments, the rock dust may have a particle size of between about 3 to about 10 microns, or from about 3 to about 9 microns, or from about 3 to about 8 microns, or from about 3 to about 7 microns, or from about 3 to about 6 microns, or from about 3 to about 5 microns, or from about 3 to about 4 microns, or about 4 to about 10 microns, or from about 4 to about 9 microns, or from about 4 to about 8 microns, or from about 4 to about 7 microns, or from about 4 to about 6 microns, or from about 4 to about 5 microns, or about 5 to about 10 microns, or from about 5 to about 9 microns, or from about 5 to about 8 microns, or from about 5 to about 7 microns, or from about 5 to about 6 microns, or about 6 to about 10 microns, or from about 6 to about 9 microns, or from about 6 to about 8 microns, or from about 6 to about 7 microns, or about 7 to about 10 microns, or from about 7 to about 9 microns, or from about 7 to about 8 microns, or about 8 to about 10 microns, or from about 8 to about 9 microns, or about 9 to about 10 microns, or about 3, 4, 5, 6, 7, 8, 9, 10 microns.

In embodiments, the rock dust may have a melt range of 3 to about 5° C., or about 4 to about 5° C., or about 3 to about 4° C., or about 3, 4, 5° C.

In embodiments, the rock dust may have a density of between about 1.65 to about 1.7 g/cm³, or from about 1.65 to about 1.69 g/cm³, or from about 1.65 to about 1.68 g/cm³, or from about 1.65 to about 1.67 g/cm³, or from about 1.65 to about 1.66 g/cm³, or about 1.66 to about 1.7 g/cm³, or from about 1.66 to about 1.69 g/cm³, or from about 1.66 to about 1.68 g/cm³, or from about 1.66 to about 1.67 g/cm³, or about 1.67 to about 1.7 g/cm³, or from about 1.67 to about 1.69 g/cm³, or from about 1.67 to about 1.68 g/cm³, or about 1.68 to about 1.7 g/cm³, or from about 1.68 to about 1.69 g/cm³, or about 1.69 to about 1.7 g/cm³, or about 1.65, 1.66, 1.67, 1.68, 1.69, or 1.7 g/cm³.

In embodiments particle size may be relatively homogeneous or may be heterogeneous within the parameters specified.

In another embodiment, the composite material of the present invention comprises sawdust. In this disclosure the term “sawdust” means and includes any form of fragmented wood material. In particular embodiments, sawdust comprises bark material. In particular embodiments the wood material is hemlock or is cedar, or combination thereof. In particular embodiments the sawdust is dried or substantially dried before use and in embodiments has a water content of less than about 8-10%. In particular embodiment, the sawdust has a water content of about 8% to about 10%, or about 9% to about 10%, or about 8% to about 8%, prior to pulverization. The remaining moisture is removed during thermos-kinetic mixing.

In particular embodiments particles of sawdust will be in the range of 40 to 60 mesh and consequently have a particle size of about 250 microns to 425 microns. It will be understood that in alternative embodiments the particles are less than about 425, 400, 375, 350, 325, 300, 275, 250 microns in size. In alternative embodiment, the particles are from about 250 to about 425 microns, or about 250 to about 400 microns, or about 250 to about 375 microns, or about 250 to about 350 microns, or about 250 to about 300 microns, or about 250 to about 275 microns, or about 275 to about 425 microns, or about 275 to about 400 microns, or about 275 to about 375 microns, or about 275 to about 350 microns, or about 275 to about 300 microns, or about 300 to about 425 microns, or about 300 to about 400 microns, or about 300 to about 375 microns, or about 300 to about 350 microns, or about 325 to about 425 microns, or about 325 to about 400 microns, or about 325 to about 375 microns, or about 325 to about 350 microns, or about 350 to about 425 microns, or about 350 to about 400 microns, or about 350 to about 375 microns, or about 375 to about 425 microns, or about 375 to about 400 microns, or about 400 to about 425 microns.

In embodiments, the composite material of the present invention comprises between about 20% to about 50% w/w, or from about 20% to about 45% w/w, or from about 20% to about 40% w/w, or from about 20% to about 35% w/w, or from about 20% to about 30% w/w, or from about 20% to about 25% w/w, or about 25% to about 50% w/w, or from about 25% to about 45% w/w, or from about 25% to about 40% w/w, or from about 25% to about 35% w/w, or from about 25% to about 30% w/w, or about 30% to about 50% w/w, or from about 30% to about 45% w/w, or from about 30% to about 40% w/w, or from about 30% to about 35% w/w, or about 35% to about 50% w/w, or from about 35% to about 45% w/w, or from about 35% to about 40% w/w, or about 40% to about 50% w/w, or from about 40% to about 45% w/w, or about 45% to about 50% w/w sawdust.

In embodiments, the composite material of the present invention may further comprise a coupling agent. Coupling agents are chemical substance capable of reacting with both the reinforcement and the resin matrix of a composite material. It may also bond inorganic fillers or fibers to organic resins to form or promote a stronger bond at the interface. The coupling agent may be applied from a solution or gas phase to the reinforcement, added to the resin, or both. Agent acts as interface between resin and glass fiber (or filler materials) to form a chemical bridge between the two. Most commonly used are organotrialkoxysilanes, titanates, zirconates and organic acid-chromium chloride coordination complexes. According to an embodiment, the coupling agent may be a maleic anhydride grafted resin. Fusabond 790™ demonstrated the good results. The coupling agent may be present in the composite material at about 1 to about 4% w/w, or about 1 to about 3% w/w, or about 1 to about 2% w/w, or about 2 to about 4% w/w, or about 2 to about 3% w/w, or about 3 to about 4% w/w.

In embodiments, the composite material of the present invention may further comprise a light stabilizer. Light stabilizers are used directly or by combinations to prevent the various effects such as oxidation, chain scission and uncontrolled recombinations and cross-linking reactions that are caused by photo-oxidation of polymers (i.e. the plastics found in the present invention). Polymers are considered to get weathered due to the direct or indirect impact of heat and ultraviolet light. The effectiveness of the stabilizers against weathering depends on solubility, ability to stabilize in different polymer matrix, the distribution in matrix, evaporation loss during processing and use. In particular embodiments, light stabilizer is a UV absorber, a UV quencher, a hindered amine light stabilizer (HALS), or combination thereof. According to an embodiment, the light stabilizer and a HALS such as for example CESA-LIGHT #7132™.

In embodiments, the composite material of the present invention comprises from about 2% to about 5% w/w, or from about 2% to about 4%, or from about 2% to about 3%, or from about 3% to about 5%, or from about 3% to about 4%, or from about 4% to about 5% of light stabilizer.

In embodiments, the composite material of the present invention may further comprise a flame retardant. Flame retardants are compounds added to manufactured materials, such as plastics and textiles, and surface finishes and coatings that inhibit, suppress, or delay the production of flames to prevent the spread of fire. They may be mixed with the base material (additive flame retardants) or chemically bonded to it (reactive flame retardants). Mineral flame retardants are typically additive while organohalogen and organophosphorus compounds can be either reactive or additive.

In particular embodiments, the flame retardant is chosen from mineral wool, gypsum, perlite, calcium silicate (Ca2SiO₄), aluminium hydroxide (AlOH), magnesium hydroxide (Mg(OH)₂), zinc borate, huntite, hydromagnesite, red phosphorus, chlorendic acid derivatives, chlorinated paraffins, decabromodiphenyl ether, decabromodiphenyl ethane, polymeric brominated compounds such as brominated polystyrenes, brominated epoxy oligomers, tetrabromophthalic anyhydride, tetrabromobisphenol A, hexabromocyclododecane, antimony trioxide, triphenyl phosphate, resorcinol bis(diphenylphosphate), bisphenol A diphenyl phosphate, and tricresyl phosphate (TCP), dimethyl methylphosphonate, aluminum diethyl phosphinate, tris(2,3-dibromopropyl)phosphate, ris(1,3-dichloro-2-propyl)phosphate, and tetrekis(2-chlorethyl)dichloroisopentyldiphosphate, and combinations thereof.

In embodiments, the flame retardant is present in the composite material of the present invention at about 1 to about 3% w/w, or from about 1 to about 2% w/w, or from about 2 to about 3% w/w, or about 1, 2, 3% w/w.

In embodiments, the composite material of the present invention may further comprise an antimicrobial agent. The antimicrobial agent may be incorporated into the composition of the composite material of the present invention, or may be coated on finished product embodiments made from the composite material of the present invention. Suitable antimicrobial agents include Zinc 2-pyridinethiol-1-oxide, N-butyl-1,2-benzisothiazolin-3-one, zinc hydrates such as 2 ZnO.B₂O₃.3.5H₂O (Borogard® GB™) or any other suitable compound known in the art and combinations thereof.

In embodiments, the antimicrobial agent is present in the composite material of the present invention at about 1 to about 4% w/w, or from about 1 to about 3% w/w, or from about 1 to about 2% w/w, or from about 2 to about 4% w/w, or from about 2 to about 3% w/w, or from about 3 to about 4% w/w, or about 1, 2, 3, 4% w/w.

In embodiments, the composite material of the present invention may further comprise a colorant, to provide the finished product embodiments made from the composite material of the present invention with an appealing color. The colorant may be incorporated into the composition of the composite material of the present invention, or may be coated on finished product embodiments. Suitable colorants include but are not limited to dyes, pigments, biological pigments, inks, paint, colored chemicals, and combinations thereof.

In embodiments, the colorant is present in the composite material of the present invention at about 1 to about 3% w/w, or from about 1 to about 2% w/w, or from about 2 to about 3% w/w, or about 1, 2, 3% w/w.

In this disclosure the relative amounts of ingredients of the composite material are described in terms of ratios. In embodiments ratios may be weight:weight, volume:volume or weight:volume. Suitable measurements will be understood and adopted by those skilled in the art in light of the materials to be quantified. In particular embodiments ratios are expressed in terms of weight:weight.

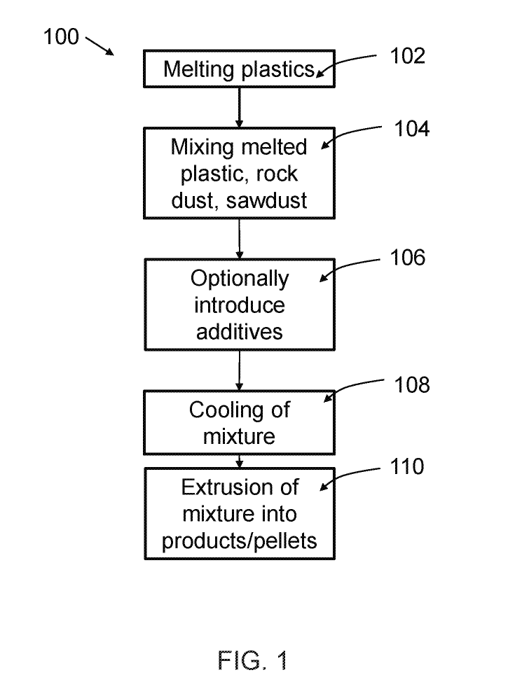

Now referring to FIG. 1, in another embodiment there is disclosed a method 100 of preparing a composite material according to the present invention, comprising step a) (104):
a) intermixing a melted low density plastic and a melted high density plastic with the sawdust and rock dust, to obtain a mixture.

In embodiments, “melting” (102) refers to heating a plastic component or mixture of components comprising plastic, so that the plastic adopts a substantially liquid consistency so that the plastic and other components can be substantially homogeneously intermixed. In embodiments melting may occur at any suitable temperature and in embodiments occurs at between about 160° C. and about 200° C. Where the plastic used is or comprises polypropylene, a suitable temperature is about 180° C. and where the plastic used is or comprises polyethylene then a suitable temperature is about 170° C., but in embodiments temperatures of about 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., 200° C., or from about 160° C. to about 200° C., or from about 161° C. to about 200° C., or from about 162° C. to about 200° C., or from about 163° C. to about 200° C., or from about 164° C. to about 200° C., or from about 165° C. to about 200° C., or from about 166° C. to about 200° C., or from about 167° C. to about 200° C., or from about 168° C. to about 200° C., or from about 169° C. to about 200° C., or from about 170° C. to about 200° C., or from about 171° C. to about 200° C., or from about 172° C. to about 200° C., or from about 173° C. to about 200° C., or from about 174° C. to about 200° C., or from about 175° C. to about 200° C., or from about 176° C. to about 200° C., or from about 177° C. to about 200° C., or from about 178° C. to about 200° C., or from about 179° C. to about 200° C., or from about 180° C. to about 200° C., or from about 181° C. to about 200° C., or from about 182° C. to about 200° C., or from about 183° C. to about 200° C., or from about 184° C. to about 200° C., or from about 185° C. to about 200° C., or from about 186° C. to about 200° C., or from about 187° C. to about 200° C., or from about 188° C. to about 200° C., or from about 189° C. to about 200° C., or from about 190° C. to about 200° C., or from about 191° C. to about 200° C., or from about 192° C. to about 200° C., or from about 193° C. to about 200° C., or from about 194° C. to about 200° C., or from about 195° C. to about 200° C., or from about 196° C. to about 200° C., or from about 197° C. to about 200° C., or from about 198° C. to about 200° C., or from about 199° C. to about 200° C., or from about 160° C. to about 199° C., or from about 161° C. to about 199° C., or from about 162° C. to about 199° C., or from about 163° C. to about 199° C., or from about 164° C. to about 199° C., or from about 165° C. to about 199° C., or from about 166° C. to about 199° C., or from about 167° C. to about 199° C., or from about 168° C. to about 199° C., or from about 169° C. to about 199° C., or from about 170° C. to about 199° C., or from about 171° C. to about 199° C., or from about 172° C. to about 199° C., or from about 173° C. to about 199° C., or from about 174° C. to about 199° C., or from about 175° C. to about 199° C., or from about 176° C. to about 199° C., or from about 177° C. to about 199° C., or from about 178° C. to about 199° C., or from about 179° C. to about 199° C., or from about 180° C. to about 199° C., or from about 181° C. to about 199° C., or from about 182° C. to about 199° C., or from about 183° C. to about 199° C., or from about 184° C. to about 199° C., or from about 185° C. to about 199° C., or from about 186° C. to about 199° C., or from about 187° C. to about 199° C., or from about 188° C. to about 199° C., or from about 189° C. to about 199° C., or from about 190° C. to about 199° C., or from about 191° C. to about 199° C., or from about 192° C. to about 199° C., or from about 193° C. to about 199° C., or from about 194° C. to about 199° C., or from about 195° C. to about 199° C., or from about 196° C. to about 199° C., or from about 197° C. to about 199° C., or from about 198° C. to about 199° C., or from about 160° C. to about 198° C., or from about 161° C. to about 198° C., or from about 162° C. to about 198° C., or from about 163° C. to about 198° C., or from about 164° C. to about 198° C., or from about 165° C. to about 198° C., or from about 166° C. to about 198° C., or from about 167° C. to about 198° C., or from about 168° C. to about 198° C., or from about 169° C. to about 198° C., or from about 170° C. to about 198° C., or from about 171° C. to about 198° C., or from about 172° C. to about 198° C., or from about 173° C. to about 198° C., or from about 174° C. to about 198° C., or from about 175° C. to about 198° C., or from about 176° C. to about 198° C., or from about 177° C. to about 198° C., or from about 178° C. to about 198° C., or from about 179° C. to about 198° C., or from about 180° C. to about 198° C., or from about 181° C. to about 198° C., or from about 182° C. to about 198° C., or from about 183° C. to about 198° C., or from about 184° C. to about 198° C., or from about 185° C. to about 198° C., or from about 186° C. to about 198° C., or from about 187° C. to about 198° C., or from about 188° C. to about 198° C., or from about 189° C. to about 198° C., or from about 190° C. to about 198° C., or from about 191° C. to about 198° C., or from about 192° C. to about 198° C., or from about 193° C. to about 198° C., or from about 194° C. to about 198° C., or from about 195° C. to about 198° C., or from about 196° C. to about 198° C., or from about 197° C. to about 198° C., or from about 160° C. to about 197° C., or from about 161° C. to about 197° C., or from about 162° C. to about 197° C., or from about 163° C. to about 197° C., or from about 164° C. to about 197° C., or from about 165° C. to about 197° C., or from about 166° C. to about 197° C., or from about 167° C. to about 197° C., or from about 168° C. to about 197° C., or from about 169° C. to about 197° C., or from about 170° C. to about 197° C., or from about 171° C. to about 197° C., or from about 172° C. to about 197° C., or from about 173° C. to about 197° C., or from about 174° C. to about 197° C., or from about 175° C. to about 197° C., or from about 176° C. to about 197° C., or from about 177° C. to about 197° C., or from about 178° C. to about 197° C., or from about 179° C. to about 197° C., or from about 180° C. to about 197° C., or from about 181° C. to about 197° C., or from about 182° C. to about 197° C., or from about 183° C. to about 197° C., or from about 184° C. to about 197° C., or from about 185° C. to about 197° C., or from about 186° C. to about 197° C., or from about 187° C. to about 197° C., or from about 188° C. to about 197° C., or from about 189° C. to about 197° C., or from about 190° C. to about 197° C., or from about 191° C. to about 197° C., or from about 192° C. to about 197° C., or from about 193° C. to about 197° C., or from about 194° C. to about 197° C., or from about 195° C. to about 197° C., or from about 196° C. to about 197° C., or from about 160° C. to about 196° C., or from about 161° C. to about 196° C., or from about 162° C. to about 196° C., or from about 163° C. to about 196° C., or from about 164° C. to about 196° C., or from about 165° C. to about 196° C., or from about 166° C. to about 196° C., or from about 167° C. to about 196° C., or from about 168° C. to about 196° C., or from about 169° C. to about 196° C., or from about 170° C. to about 196° C., or from about 171° C. to about 196° C., or from about 172° C. to about 196° C., or from about 173° C. to about 196° C., or from about 174° C. to about 196° C., or from about 175° C. to about 196° C., or from about 176° C. to about 196° C., or from about 177° C. to about 196° C., or from about 178° C. to about 196° C., or from about 179° C. to about 196° C., or from about 180° C. to about 196° C., or from about 181° C. to about 196° C., or from about 182° C. to about 196° C., or from about 183° C. to about 196° C., or from about 184° C. to about 196° C., or from about 185° C. to about 196° C., or from about 186° C. to about 196° C., or from about 187° C. to about 196° C., or from about 188° C. to about 196° C., or from about 189° C. to about 196° C., or from about 180° C. to about 196° C., or from about 191° C. to about 196° C., or from about 192° C. to about 196° C., or from about 193° C. to about 196° C., or from about 194° C. to about 196° C., or from about 195° C. to about 196° C., or from about 160° C. to about 195° C., or from about 161° C. to about 195° C., or from about 162° C. to about 195° C., or from about 163° C. to about 195° C., or from about 164° C. to about 195° C., or from about 165° C. to about 195° C., or from about 166° C. to about 195° C., or from about 167° C. to about 195° C., or from about 168° C. to about 195° C., or from about 169° C. to about 195° C., or from about 170° C. to about 195° C., or from about 171° C. to about 195° C., or from about 172° C. to about 195° C., or from about 173° C. to about 195° C., or from about 174° C. to about 195° C., or from about 175° C. to about 195° C., or from about 176° C. to about 195° C., or from about 177° C. to about 195° C., or from about 178° C. to about 195° C., or from about 179° C. to about 195° C., or from about 180° C. to about 195° C., or from about 181° C. to about 195° C., or from about 182° C. to about 195° C., or from about 183° C. to about 195° C., or from about 184° C. to about 195° C., or from about 185° C. to about 195° C., or from about 186° C. to about 195° C., or from about 187° C. to about 195° C., or from about 188° C. to about 195° C., or from about 189° C. to about 195° C., or from about 190° C. to about 195° C., or from about 191° C. to about 195° C., or from about 192° C. to about 195° C., or from about 193° C. to about 195° C., or from about 194° C. to about 195° C., or from about 195° C. to about 195° C., or from about 160° C. to about 194° C., or from about 161° C. to about 194° C., or from about 162° C. to about 194° C., or from about 163° C. to about 194° C., or from about 164° C. to about 194° C., or from about 165° C. to about 194° C., or from about 166° C. to about 194° C., or from about 167° C. to about 194° C., or from about 168° C. to about 194° C., or from about 169° C. to about 194° C., or from about 170° C. to about 194° C., or from about 171° C. to about 194° C., or from about 172° C. to about 194° C., or from about 173° C. to about 194° C., or from about 174° C. to about 194° C., or from about 175° C. to about 194° C., or from about 176° C. to about 194° C., or from about 177° C. to about 194° C., or from about 178° C. to about 194° C., or from about 179° C. to about 194° C., or from about 180° C. to about 194° C., or from about 181° C. to about 194° C., or from about 182° C. to about 194° C., or from about 183° C. to about 194° C., or from about 184° C. to about 194° C., or from about 185° C. to about 194° C., or from about 186° C. to about 194° C., or from about 187° C. to about 194° C., or from about 188° C. to about 194° C., or from about 189° C. to about 194° C., or from about 180° C. to about 194° C., or from about 191° C. to about 194° C., or from about 192° C. to about 194° C., or from about 193° C. to about 194° C., or from about 160° C. to about 193° C., or from about 161° C. to about 193° C., or from about 162° C. to about 193° C., or from about 163° C. to about 193° C., or from about 164° C. to about 193° C., or from about 165° C. to about 193° C., or from about 166° C. to about 193° C., or from about 167° C. to about 193° C., or from about 168° C. to about 193° C., or from about 169° C. to about 193° C., or from about 170° C. to about 193° C., or from about 171° C. to about 193° C., or from about 172° C. to about 193° C., or from about 173° C. to about 193° C., or from about 174° C. to about 193° C., or from about 175° C. to about 193° C., or from about 176° C. to about 193° C., or from about 177° C. to about 193° C., or from about 178° C. to about 193° C., or from about 179° C. to about 193° C., or from about 180° C. to about 193° C., or from about 181° C. to about 193° C., or from about 182° C. to about 193° C., or from about 183° C. to about 193° C., or from about 184° C. to about 193° C., or from about 185° C. to about 193° C., or from about 186° C. to about 193° C., or from about 187° C. to about 193° C., or from about 188° C. to about 193° C., or from about 189° C. to about 193° C., or from about 190° C. to about 193° C., or from about 191° C. to about 193° C., or from about 192° C. to about 193° C., or from about 160° C. to about 192° C., or from about 161° C. to about 192° C., or from about 162° C. to about 192° C., or from about 163° C. to about 192° C., or from about 164° C. to about 192° C., or from about 165° C. to about 192° C., or from about 166° C. to about 192° C., or from about 167° C. to about 192° C., or from about 168° C. to about 192° C., or from about 169° C. to about 192° C., or from about 170° C. to about 192° C., or from about 171° C. to about 192° C., or from about 172° C. to about 192° C., or from about 173° C. to about 192° C., or from about 174° C. to about 192° C., or from about 175° C. to about 192° C., or from about 176° C. to about 192° C., or from about 177° C. to about 192° C., or from about 178° C. to about 192° C., or from about 179° C. to about 192° C., or from about 180° C. to about 192° C., or from about 181° C. to about 192° C., or from about 182° C. to about 192° C., or from about 183° C. to about 192° C., or from about 184° C. to about 192° C., or from about 185° C. to about 192° C., or from about 186° C. to about 192° C., or from about 187° C. to about 192° C., or from about 188° C. to about 192° C., or from about 189° C. to about 192° C., or from about 190° C. to about 192° C., or from about 191° C. to about 192° C., or from about 160° C. to about 191° C., or from about 161° C. to about 191° C., or from about 162° C. to about 191° C., or from about 163° C. to about 191° C., or from about 164° C. to about 191° C., or from about 165° C. to about 191° C., or from about 166° C. to about 191° C., or from about 167° C. to about 191° C., or from about 168° C. to about 191° C., or from about 169° C. to about 191° C., or from about 170° C. to about 191° C., or from about 171° C. to about 191° C., or from about 172° C. to about 191° C., or from about 173° C. to about 191° C., or from about 174° C. to about 191° C., or from about 175° C. to about 191° C., or from about 176° C. to about 191° C., or from about 177° C. to about 191° C., or from about 178° C. to about 191° C., or from about 179° C. to about 191° C., or from about 180° C. to about 191° C., or from about 181° C. to about 191° C., or from about 182° C. to about 191° C., or from about 183° C. to about 191° C., or from about 184° C. to about 191° C., or from about 185° C. to about 191° C., or from about 186° C. to about 191° C., or from about 187° C. to about 191° C., or from about 188° C. to about 191° C., or from about 189° C. to about 191° C., or from about 190° C. to about 191° C., or from about 160° C. to about 190° C., or from about 161° C. to about 190° C., or from about 162° C. to about 190° C., or from about 163° C. to about 190° C., or from about 164° C. to about 190° C., or from about 165° C. to about 190° C., or from about 166° C. to about 190° C., or from about 167° C. to about 190° C., or from about 168° C. to about 190° C., or from about 169° C. to about 190° C., or from about 170° C. to about 190° C., or from about 171° C. to about 190° C., or from about 172° C. to about 190° C., or from about 173° C. to about 190° C., or from about 174° C. to about 190° C., or from about 175° C. to about 190° C., or from about 176° C. to about 190° C., or from about 177° C. to about 190° C., or from about 178° C. to about 190° C., or from about 179° C. to about 190° C., or from about 180° C. to about 190° C., or from about 181° C. to about 190° C., or from about 182° C. to about 190° C., or from about 183° C. to about 190° C., or from about 184° C. to about 190° C., or from about 185° C. to about 190° C., or from about 186° C. to about 190° C., or from about 187° C. to about 190° C., or from about 188° C. to about 190° C., or from about 189° C. to about 190° C., or from about 160° C. to about 189° C., or from about 161° C. to about 189° C., or from about 162° C. to about 189° C., or from about 163° C. to about 189° C., or from about 164° C. to about 189° C., or from about 165° C. to about 189° C., or from about 166° C. to about 189° C., or from about 167° C. to about 189° C., or from about 168° C. to about 189° C., or from about 169° C. to about 189° C., or from about 170° C. to about 189° C., or from about 171° C. to about 189° C., or from about 172° C. to about 189° C., or from about 173° C. to about 189° C., or from about 174° C. to about 189° C., or from about 175° C. to about 189° C., or from about 176° C. to about 189° C., or from about 177° C. to about 189° C., or from about 178° C. to about 189° C., or from about 179° C. to about 189° C., or from about 180° C. to about 189° C., or from about 181° C. to about 189° C., or from about 182° C. to about 189° C., or from about 183° C. to about 189° C., or from about 184° C. to about 189° C., or from about 185° C. to about 189° C., or from about 186° C. to about 189° C., or from about 187° C. to about 189° C., or from about 188° C. to about 189° C., or from about 160° C. to about 188° C., or from about 161° C. to about 188° C., or from about 162° C. to about 188° C., or from about 163° C. to about 188° C., or from about 164° C. to about 188° C., or from about 165° C. to about 188° C., or from about 166° C. to about 188° C., or from about 167° C. to about 188° C., or from about 168° C. to about 188° C., or from about 169° C. to about 188° C., or from about 170° C. to about 188° C., or from about 171° C. to about 188° C., or from about 172° C. to about 188° C., or from about 173° C. to about 188° C., or from about 174° C. to about 188° C., or from about 175° C. to about 188° C., or from about 176° C. to about 188° C., or from about 177° C. to about 188° C., or from about 178° C. to about 188° C., or from about 179° C. to about 188° C., or from about 180° C. to about 188° C., or from about 181° C. to about 188° C., or from about 182° C. to about 188° C., or from about 183° C. to about 188° C., or from about 184° C. to about 188° C., or from about 185° C. to about 188° C., or from about 186° C. to about 188° C., or from about 187° C. to about 188° C., or from about 160° C. to about 187° C., or from about 161° C. to about 187° C., or from about 162° C. to about 187° C., or from about 163° C. to about 187° C., or from about 164° C. to about 187° C., or from about 165° C. to about 187° C., or from about 166° C. to about 187° C., or from about 167° C. to about 187° C., or from about 168° C. to about 187° C., or from about 169° C. to about 187° C., or from about 170° C. to about 187° C., or from about 171° C. to about 187° C., or from about 172° C. to about 187° C., or from about 173° C. to about 187° C., or from about 174° C. to about 187° C., or from about 175° C. to about 187° C., or from about 176° C. to about 187° C., or from about 177° C. to about 187° C., or from about 178° C. to about 187° C., or from about 179° C. to about 187° C., or from about 180° C. to about 187° C., or from about 181° C. to about 187° C., or from about 182° C. to about 187° C., or from about 183° C. to about 187° C., or from about 184° C. to about 187° C., or from about 185° C. to about 187° C., or from about 186° C. to about 187° C., or from about 160° C. to about 186° C., or from about 161° C. to about 186° C., or from about 162° C. to about 186° C., or from about 163° C. to about 186° C., or from about 164° C. to about 186° C., or from about 165° C. to about 186° C., or from about 166° C. to about 186° C., or from about 167° C. to about 186° C., or from about 168° C. to about 186° C., or from about 169° C. to about 186° C., or from about 170° C. to about 186° C., or from about 171° C. to about 186° C., or from about 172° C. to about 186° C., or from about 173° C. to about 186° C., or from about 174° C. to about 186° C., or from about 175° C. to about 186° C., or from about 176° C. to about 186° C., or from about 177° C. to about 186° C., or from about 178° C. to about 186° C., or from about 179° C. to about 186° C., or from about 180° C. to about 186° C., or from about 181° C. to about 186° C., or from about 182° C. to about 186° C., or from about 183° C. to about 186° C., or from about 184° C. to about 186° C., or from about 185° C. to about 186° C., or from about 160° C. to about 185° C., or from about 161° C. to about 185° C., or from about 162° C. to about 185° C., or from about 163° C. to about 185° C., or from about 164° C. to about 185° C., or from about 165° C. to about 185° C., or from about 166° C. to about 185° C., or from about 167° C. to about 185° C., or from about 168° C. to about 185° C., or from about 169° C. to about 185° C., or from about 170° C. to about 185° C., or from about 171° C. to about 185° C., or from about 172° C. to about 185° C., or from about 173° C. to about 185° C., or from about 174° C. to about 185° C., or from about 175° C. to about 185° C., or from about 176° C. to about 185° C., or from about 177° C. to about 185° C., or from about 178° C. to about 185° C., or from about 179° C. to about 185° C., or from about 180° C. to about 185° C., or from about 181° C. to about 185° C., or from about 182° C. to about 185° C., or from about 183° C. to about 185° C., or from about 184° C. to about 185° C., or from about 160° C. to about 184° C., or from about 161° C. to about 184° C., or from about 162° C. to about 184° C., or from about 163° C. to about 184° C., or from about 164° C. to about 184° C., or from about 165° C. to about 184° C., or from about 166° C. to about 184° C., or from about 167° C. to about 184° C., or from about 168° C. to about 184° C., or from about 169° C. to about 184° C., or from about 170° C. to about 184° C., or from about 171° C. to about 184° C., or from about 172° C. to about 184° C., or from about 173° C. to about 184° C., or from about 174° C. to about 184° C., or from about 175° C. to about 184° C., or from about 176° C. to about 184° C., or from about 177° C. to about 184° C., or from about 178° C. to about 184° C., or from about 179° C. to about 184° C., or from about 180° C. to about 184° C., or from about 181° C. to about 184° C., or from about 182° C. to about 184° C., or from about 183° C. to about 184° C., or from about 160° C. to about 183° C., or from about 161° C. to about 183° C., or from about 162° C. to about 183° C., or from about 163° C. to about 183° C., or from about 164° C. to about 183° C., or from about 165° C. to about 183° C., or from about 166° C. to about 183° C., or from about 167° C. to about 183° C., or from about 168° C. to about 183° C., or from about 169° C. to about 183° C., or from about 170° C. to about 183° C., or from about 171° C. to about 183° C., or from about 172° C. to about 183° C., or from about 173° C. to about 183° C., or from about 174° C. to about 183° C., or from about 175° C. to about 183° C., or from about 176° C. to about 183° C., or from about 177° C. to about 183° C., or from about 178° C. to about 183° C., or from about 179° C. to about 183° C., or from about 180° C. to about 183° C., or from about 181° C. to about 183° C., or from about 182° C. to about 183° C., or from about 160° C. to about 182° C., or from about 161° C. to about 182° C., or from about 162° C. to about 182° C., or from about 163° C. to about 182° C., or from about 164° C. to about 182° C., or from about 165° C. to about 182° C., or from about 166° C. to about 182° C., or from about 167° C. to about 182° C., or from about 168° C. to about 182° C., or from about 169° C. to about 182° C., or from about 170° C. to about 182° C., or from about 171° C. to about 182° C., or from about 172° C. to about 182° C., or from about 173° C. to about 182° C., or from about 174° C. to about 182° C., or from about 175° C. to about 182° C., or from about 176° C. to about 182° C., or from about 177° C. to about 182° C., or from about 178° C. to about 182° C., or from about 179° C. to about 182° C., or from about 180° C. to about 182° C., or from about 181° C. to about 182° C., or from about 160° C. to about 181° C., or from about 161° C. to about 181° C., or from about 162° C. to about 181° C., or from about 163° C. to about 181° C., or from about 164° C. to about 181° C., or from about 165° C. to about 181° C., or from about 166° C. to about 181° C., or from about 167° C. to about 181° C., or from about 168° C. to about 181° C., or from about 169° C. to about 181° C., or from about 170° C. to about 181° C., or from about 171° C. to about 181° C., or from about 172° C. to about 181° C., or from about 173° C. to about 181° C., or from about 174° C. to about 181° C., or from about 175° C. to about 181° C., or from about 176° C. to about 181° C., or from about 177° C. to about 181° C., or from about 178° C. to about 181° C., or from about 179° C. to about 181° C., or from about 180° C. to about 181° C., or from about 160° C. to about 180° C., or from about 161° C. to about 180° C., or from about 162° C. to about 180° C., or from about 163° C. to about 180° C., or from about 164° C. to about 180° C., or from about 165° C. to about 180° C., or from about 166° C. to about 180° C., or from about 167° C. to about 180° C., or from about 168° C. to about 180° C., or from about 169° C. to about 180° C., or from about 170° C. to about 180° C., or from about 171° C. to about 180° C., or from about 172° C. to about 180° C., or from about 173° C. to about 180° C., or from about 174° C. to about 180° C., or from about 175° C. to about 180° C., or from about 176° C. to about 180° C., or from about 177° C. to about 180° C., or from about 178° C. to about 180° C., or from about 179° C. to about 180° C., or from about 160° C. to about 179° C., or from about 161° C. to about 179° C., or from about 162° C. to about 179° C., or from about 163° C. to about 179° C., or from about 164° C. to about 179° C., or from about 165° C. to about 179° C., or from about 166° C. to about 179° C., or from about 167° C. to about 179° C., or from about 168° C. to about 179° C., or from about 169° C. to about 179° C., or from about 170° C. to about 179° C., or from about 171° C. to about 179° C., or from about 172° C. to about 179° C., or from about 173° C. to about 179° C., or from about 174° C. to about 179° C., or from about 175° C. to about 179° C., or from about 176° C. to about 179° C., or from about 177° C. to about 179° C., or from about 178° C. to about 179° C., or from about 160° C. to about 178° C., or from about 161° C. to about 178° C., or from about 162° C. to about 178° C., or from about 163° C. to about 178° C., or from about 164° C. to about 178° C., or from about 165° C. to about 178° C., or from about 166° C. to about 178° C., or from about 167° C. to about 178° C., or from about 168° C. to about 178° C., or from about 169° C. to about 178° C., or from about 170° C. to about 178° C., or from about 171° C. to about 178° C., or from about 172° C. to about 178° C., or from about 173° C. to about 178° C., or from about 174° C. to about 178° C., or from about 175° C. to about 178° C., or from about 176° C. to about 178° C., or from about 177° C. to about 178° C., or from about 160° C. to about 177° C., or from about 161° C. to about 177° C., or from about 162° C. to about 177° C., or from about 163° C. to about 177° C., or from about 164° C. to about 177° C., or from about 165° C. to about 177° C., or from about 166° C. to about 177° C., or from about 167° C. to about 177° C., or from about 168° C. to about 177° C., or from about 169° C. to about 177° C., or from about 170° C. to about 177° C., or from about 171° C. to about 177° C., or from about 172° C. to about 177° C., or from about 173° C. to about 177° C., or from about 174° C. to about 177° C., or from about 175° C. to about 177° C., or from about 176° C. to about 177° C., or from about 160° C. to about 176° C., or from about 161° C. to about 176° C., or from about 162° C. to about 176° C., or from about 163° C. to about 176° C., or from about 164° C. to about 176° C., or from about 165° C. to about 176° C., or from about 166° C. to about 176° C., or from about 167° C. to about 176° C., or from about 168° C. to about 176° C., or from about 169° C. to about 176° C., or from about 170° C. to about 176° C., or from about 171° C. to about 176° C., or from about 172° C. to about 176° C., or from about 173° C. to about 176° C., or from about 174° C. to about 176° C., or from about 175° C. to about 176° C., or from about 160° C. to about 175° C., or from about 161° C. to about 175° C., or from about 162° C. to about 175° C., or from about 163° C. to about 175° C., or from about 164° C. to about 175° C., or from about 165° C. to about 175° C., or from about 166° C. to about 175° C., or from about 167° C. to about 175° C., or from about 168° C. to about 175° C., or from about 169° C. to about 175° C., or from about 170° C. to about 175° C., or from about 171° C. to about 175° C., or from about 172° C. to about 175° C., or from about 173° C. to about 175° C., or from about 174° C. to about 175° C., or from about 160° C. to about 174° C., or from about 161° C. to about 174° C., or from about 162° C. to about 174° C., or from about 163° C. to about 174° C., or from about 164° C. to about 174° C., or from about 165° C. to about 174° C., or from about 166° C. to about 174° C., or from about 167° C. to about 174° C., or from about 168° C. to about 174° C., or from about 169° C. to about 174° C., or from about 170° C. to about 174° C., or from about 171° C. to about 174° C., or from about 172° C. to about 174° C., or from about 173° C. to about 174° C., or from about 160° C. to about 173° C., or from about 161° C. to about 173° C., or from about 162° C. to about 173° C., or from about 163° C. to about 173° C., or from about 164° C. to about 173° C., or from about 165° C. to about 173° C., or from about 166° C. to about 173° C., or from about 167° C. to about 173° C., or from about 168° C. to about 173° C., or from about 169° C. to about 173° C., or from about 170° C. to about 173° C., or from about 171° C. to about 173° C., or from about 172° C. to about 173° C., or from about 160° C. to about 172° C., or from about 161° C. to about 172° C., or from about 162° C. to about 172° C., or from about 163° C. to about 172° C., or from about 164° C. to about 172° C., or from about 165° C. to about 172° C., or from about 166° C. to about 172° C., or from about 167° C. to about 172° C., or from about 168° C. to about 172° C., or from about 169° C. to about 172° C., or from about 170° C. to about 172° C., or from about 171° C. to about 172° C., or from about 160° C. to about 171° C., or from about 161° C. to about 171° C., or from about 162° C. to about 171° C., or from about 163° C. to about 171° C., or from about 164° C. to about 171° C., or from about 165° C. to about 171° C., or from about 166° C. to about 171° C., or from about 167° C. to about 171° C., or from about 168° C. to about 171° C., or from about 169° C. to about 171° C., or from about 170° C. to about 171° C., or from about 160° C. to about 170° C., or from about 161° C. to about 170° C., or from about 162° C. to about 170° C., or from about 163° C. to about 170° C., or from about 164° C. to about 170° C., or from about 165° C. to about 170° C., or from about 166° C. to about 170° C., or from about 167° C. to about 170° C., or from about 168° C. to about 170° C., or from about 169° C. to about 170° C., or from about 160° C. to about 169° C., or from about 161° C. to about 169° C., or from about 162° C. to about 169° C., or from about 163° C. to about 169° C., or from about 164° C. to about 169° C., or from about 165° C. to about 169° C., or from about 166° C. to about 169° C., or from about 167° C. to about 169° C., or from about 168° C. to about 169° C., or from about 160° C. to about 168° C., or from about 161° C. to about 168° C., or from about 162° C. to about 168° C., or from about 163° C. to about 168° C., or from about 164° C. to about 168° C., or from about 165° C. to about 168° C., or from about 166° C. to about 168° C., or from about 167° C. to about 168° C., or from about 160° C. to about 167° C., or from about 161° C. to about 167° C., or from about 162° C. to about 167° C., or from about 163° C. to about 167° C., or from about 164° C. to about 167° C., or from about 165° C. to about 167° C., or from about 166° C. to about 167° C., or from about 160° C. to about 166° C., or from about 161° C. to about 166° C., or from about 162° C. to about 166° C., or from about 163° C. to about 166° C., or from about 164° C. to about 166° C., or from about 165° C. to about 166° C., or from about 160° C. to about 165° C., or from about 161° C. to about 165° C., or from about 162° C. to about 165° C., or from about 163° C. to about 165° C., or from about 164° C. to about 165° C., or from about 160° C. to about 164° C., or from about 161° C. to about 164° C., or from about 162° C. to about 164° C., or from about 163° C. to about 164° C., or from about 160° C. to about 163° C., or from about 161° C. to about 163° C., or from about 162° C. to about 163° C., or from about 160° C. to about 162° C., or from about 161° C. to about 162° C., or from about 160° C. to about 161° C., or greater than about 200° C. will be suitable. Those skilled in the art will readily select a suitable melting temperature to take account of the properties of the particular plastic used and of the mixture of components.

In embodiments heating, melting (102) and mixing (104) occur for any suitable time period. In particular embodiments, components for the composition are heated and mixed for between about 5 minutes and about 8 minutes, or about 5 minutes to about 7 minutes, or about 5 minutes to about 6 minutes, or about 6 minutes and about 8 minutes, or about 6 minutes to about 7 minutes, or about 7 minutes and about 8 minutes, or about 5, or about 6 or about 7, or about 8 minutes before the mixture is considered ready for cooling. In embodiments the mixture is heated for up to about 3, 4, 5, 6, 7, 8, 9, 10, 11, 12, 13, 14, 15, 20, 25 or more minutes or for less than about 25, 20, 15, 14, 13, 12, 10, 9, 8 or fewer minutes. In alternative embodiments any suitable combination of temperature, mixing method and time, will be adopted to suit particular purposes.

In embodiment, the melting step occurs in a closed vessel. In alternative embodiments the plastic is pre-melted before other components are added and in other alternative embodiments two or more components are heated simultaneously. In embodiments the melting occurs in a closed vessel. In embodiments oxygen is excluded and in embodiments is not excluded. In embodiments the heating and mixing occur in an extrusion mixer or double extrusion mixer. Those skilled in the art will readily identify suitable models and procedures.

According to another embodiment, the method of the present invention may comprise step b) (108) of cooling the mixture of plastic on a conveyor. In embodiments the mixture is cooled on a conveyor. In embodiments the mixture is extruded. In alternative embodiments the mixture is dispensed in pellets and is shaped by press. In embodiments the formed composite material is cooled over a distance of about 60 to 80 feet (18 to 25 meters) of conveyor at ambient (room) temperature. In embodiments the composite material is actively cooled using cooled air other suitable means, all of which will be readily identified and implemented by those skilled in the art.

In embodiments of the method of the present invention, the composite material comprises one or more additives (106), such as light stabilizers to prolong life of products made from the composite material, flame retardants to reduce burning speed of material in products incorporating the composite material in their build, antimicrobial agents to prevent or reduce the growth of algae, bacteria or mosses, and the likes. In embodiments additives are intermixed with the other ingredients, or coated on the finished product.

According to another embodiment, the method may also include step c) (110) extruding the mixture to obtain a product therefrom. In embodiments there is disclosed a shingle or siding panel formed from the composition according to embodiments. In embodiments there is disclosed a method for making shingles, the method comprising forming and shaping the composite material according to embodiments.

In particular embodiment, the extruding step may comprise forming and shaping the composite material according to a shape of the desired product, for example, according to a preferred embodiment a shingle.

According to another embodiment of the present invention, hot melt cutting technology may replace the wood-plastic composite extrusion/pelletizing technology, typically used to manufacture wood-plastic composite pellets. An ultrahigh-speed thermo-kinetic mixer/compounder is used to produce a fully dispersed, fully fluxed, uniformly blended compound with zero % moisture content. The compound will discharge into a customized Hot Melt Cutter enclosed within a Temperature/Humidity controlled chamber. The cut material will then be fed directly into the Shingle forming equipment, ensuring a closed loop material feed.

The present invention will be more readily understood by referring to the following examples which are given to illustrate the invention rather than to limit its scope.

### EXAMPLE 1

### COMPOSITE MATERIAL EXAMPLES

TABLE 1
Example composite material compositions

| | Injection | Injection | Injection | Extrusion | Extrusion |
|---|---|---|---|---|---|
| | #1 | #2 | #3 | #1 | #2 |
| Component | (% w/w) | (% w/w) | (% w/w) | (% w/w) | (% w/w) |
| Sawdust | 20 | 25 | 30 | 40 | 48 |
| High density | 30 | 32 | 34 | 35 | 36 |
| polymer | | | | | |
| (HDPE) | | | | | |
| Low density | 3 | 3 | 3 | 4 | 4 |
| polymer | | | | | |
| (LLDPE) | | | | | |
| Rock dust | 37 | 30 | 23 | 9 | 0 |
| (calcium | | | | | |
| carbonate) | | | | | |
| coupling | 2 | 2 | 2 | 2 | 2 |
| agent | | | | | |
| Anti- | 2 | 2 | 2 | 3 | 3 |
| microbial | | | | | |
| Light | 2 | 2 | 2 | 3 | 3 |
| stabilizer | | | | | |
| Flame | 2 | 2 | 2 | 2 | 2 |
| retardant | | | | | |
| Colorant | 2 | 2 | 2 | 2 | 2 |

Mixture of 50 mesh limestone powder, about shredded low density polyethylene waste and high density polyethylene waste, and 40-60 mesh hemlock wood dust, CPLG agent, antimicrobial, light stabilizer, flame retardant, and colorant were heated to about 180° C. in a closed vessel in a double mixer-extruder for between 5 and 8 minutes. The homogenized mixture was poured onto a flat surface and allowed to cool at ambient temperature. The resulting material was strong, rigid, and was less fragile than a simple plastic/rock mixture.

The embodiments and examples presented herein are illustrative of the general nature of the subject matter hereof and are not limiting. It will be understood by those skilled in the art how these embodiments can be readily modified and/or adapted for various applications and in various ways without departing from the spirit and scope of the subject matter disclosed. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed. Particular embodiments may alternatively comprise or consist of or exclude any one or more of the elements disclosed.

1. A composite material comprising:
a) between about 2% to about 5% w/w low density plastic;
b) between about 30% to about 38% w/w high density plastic;
c) between about 0% to about 40% w/w rock dust;
d) between about 20% to about 50% w/w sawdust; and
e) a coupling agent.

2. The composite material of claim 1, wherein said sawdust is hemlock sawdust, cedar sawdust or combinations thereof.

3. The composite material of claim 1, wherein said sawdust has a particle size of between about 250 and about 425 microns (60 to 40 mesh).

4. The composite material of claim 1, wherein said rock dust has a particle size of between about 3 and about 10 microns, or about 4 to about 5 microns.

5. The composite material of claim 1, wherein said rock dust is a calcium carbonate (CaCO₃) mineral.

6. The composite material of claim 5, wherein said calcium carbonate (CaCO₃) mineral is calcite, aragonite, or a combination thereof.

7. The composite material of claim 5, wherein said calcium carbonate (CaCO₃) mineral is limestone.

8. The composite material of claim 1, wherein said low density plastic is low density polyethylene, low density polypropylene, or a combination thereof.

9. The composite material of claim 1, wherein said low density plastic or said high density plastic is a polyvinylchloride (PVC), a polyethylene, a terephthalate (PET), a polytetrafluoroethylene (PTFE), a polystyrene, a polyvinylidine chloride.

10. The composite material of claim 1, wherein said high density plastic is high density polyethylene, high density polypropylene, or a combination thereof.

11. The composite material of claim 1, wherein said low density plastic or said high density plastic is recycled plastic.

12. The composite material of claim 1, wherein said coupling agent is a maleic anhydride-grafted resin.

13. The composite material of claim 1, wherein said coupling agent is at about 1 to about 4% w/w of the composition.

14. The composite material of claim 1, further comprising a light stabilizer.

15. The composition material of claim 15, wherein said light stabilizer is a UV absorber, a UV quencher, a hindered amine light stabilizer (HALS), or combinations thereof.

16. The composite material of claim 14, wherein said composite material comprises from about 2% to about 5% w/w of said light stabilizer.

17. The composite material of claim 1, further comprising a flame retardant.

18. The composite material of claim 17, wherein said flame retardant is mineral wool, gypsum, perlite, calcium silicate (Ca₂SiO₄), aluminium hydroxide (AlOH), magnesium hydroxide (Mg(OH)₂), zinc borate, huntite, hydromagnesite, red phosphorus, chlorendic acid derivatives, chlorinated paraffins, decabromodiphenyl ether, decabromodiphenyl ethane, polymeric brominated compounds such as brominated polystyrenes, brominated epoxy oligomers, tetrabromophthalic anyhydride, tetrabromobisphenol A, hexabromocyclododecane, antimony trioxide, triphenyl phosphate, resorcinol bis(diphenylphosphate), bisphenol A diphenyl phosphate, and tricresyl phosphate (TCP), dimethyl methylphosphonate, aluminum diethyl phosphinate, tris(2,3-dibromopropyl)phosphate, tris(1,3-dichloro-2-propyl)phosphate, and tetrekis(2-chlorethyl)dichloroisopentyldiphosphate, and combinations thereof.

19. The composite material of claim 1, further comprising a colorant.

20. The composite material of claim 1, further comprising an antimicrobial agent.
